(19) United States
(12) Patent Application Publication
(10) Pub. No.: US 2026/0328602 A1
(43) Pub. Date: Oct. 22, 2026

(54) JOINT STRUCTURE

(71) Applicant: TOKYO KEISO CO., LTD., TOKYO (JP)

(72) Inventor: KOUHEI YONEMURA, TOKYO (JP)

(21) Appl. No.: 19/642,648

(22) Filed: Apr. 9, 2026

(30) Foreign Application Priority Data
Apr. 9, 2025 (JP) 2025-064528

(51) Int. Cl. G01F 1/66

(52) U.S. Cl. CPC G01F 1/662

(57) ABSTRACT

When linking structural bodies that include fluid conduits, linking can be carried out easily and while conserving space. An ultrasonic flowmeter is such that element attachment members are linked one each to either side of a measuring pipe member. Each member includes a fluid conduit along which a fluid to be measured flows. Flanges that are linked one to each of the element attachment members protrude one at either end of the measuring pipe member. The flanges are of an approximately rectangular form disposed in such a way as to enclose a conduit. A link fitting that links flanges is formed of a pair of parallel clamping pieces and three joining pieces that link the clamping pieces. Linking of the members is carried out by clamping by fitting the link fitting from both sides to a linking portion in one place in which flanges are combined.

### CROSS-REFERENCE TO RELATED PATENT APPLICATION

This application claims the benefit of priority to Japanese Patent Application No. 2025-064528, filed on Apr. 9, 2025. The entire content of the above identified application is incorporated herein by reference.

### FIELD OF THE DISCLOSURE

The present application relates to a joint structure that is used in an ultrasonic flowmeter or a flow controller, and that links structural bodies that include a fluid conduit.

### BACKGROUND OF THE DISCLOSURE

An ultrasonic flowmeter such that a measuring pipe, an inflow pipe, and an outflow pipe made of PFA are attached by welding to a piping block that is also made of PFA is disclosed in Patent Literature 1.

### CITATION LIST

### Patent Literature

PTL 1: JP2012-230095A

### SUMMARY OF THE DISCLOSURE

However, when assembling piping by welding, as is the case with the ultrasonic flowmeter of JP2010-230095A, the heat effect is considerable, and in addition to an accompanying difficulty in terms of welding technology, burr or the like is liable to occur in an internal conduit on an inner side of a welded place. The burr affects a flow velocity distribution of a fluid, causing performance as a measuring device to deteriorate.

Also, with regard to a connection of pipe bodies and the like, threaded couplings and the like, such that an external screw portion and an internal screw portion provided in an end portion are linked by being screwed together, are widely used, but time and effort is required for attachment, replacement, and the like of these couplings, and a long attachment space is needed for a longitudinal direction, meaning that space conservation is difficult.

An object of the present application is to provide a joint structure such that when linking structural bodies that include a fluid conduit, welding and the like is unnecessary, and the structural bodies can be linked easily and while conserving space, thereby resolving the aforementioned problems.

In this way, the joint structure according to the present application is such that when linking structural bodies that include a fluid conduit, a welding operation, an operation of screwing using an external screw portion and an internal screw portion, and the like are unnecessary, and the structural bodies can be linked easily while conserving space.

### BRIEF DESCRIPTION OF THE DRAWINGS

FIG. 1 is an exploded perspective view of an ultrasonic flowmeter before linking using a joint structure.

FIG. 2 is a perspective view of the ultrasonic flowmeter after linking.

FIG. 3 is an enlarged perspective view of a linking portion before linking.

### DETAILED DESCRIPTION OF THE EXEMPLARY EMBODIMENTS

Hereafter, the present application will be described in detail, based on a working example shown in the drawings.

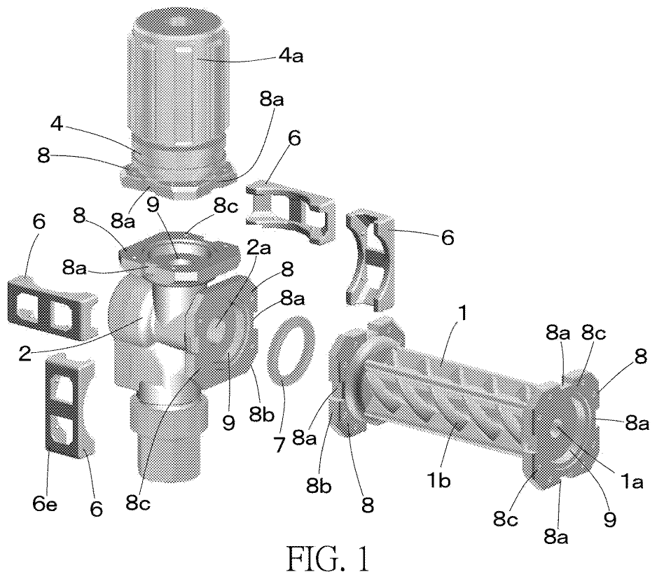

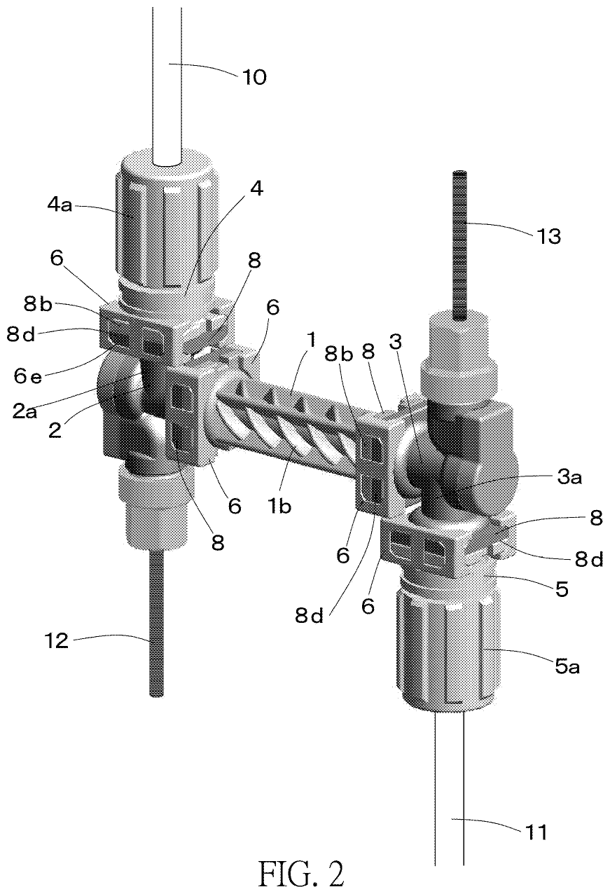

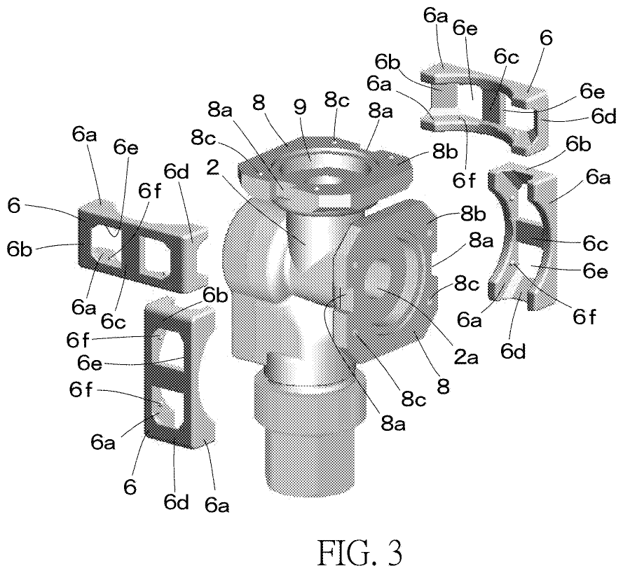

FIG. 1 is an exploded perspective view of an ultrasonic flowmeter before linking using a joint structure, FIG. 2 is a perspective view of the ultrasonic flowmeter after linking, and FIG. 3 is an enlarged perspective view of a linking portion before linking.

The ultrasonic flowmeter is configured of one measuring pipe member 1, first and second element attachment members 2 and 3 linked one to either end of the measuring pipe member 1, an inflow pipe member 4 linked to another end portion of the first element attachment member 2, and a discharge pipe member 5 linked to another end portion of the second element attachment member 3.

These members 1 to 5 are molded from, for example, a synthetic resin material, and have in common that each is a structural body that configures a fluid conduit along which a fluid to be measured flows. Also, a link fitting 6, formed from, for example, a synthetic resin material, for linking the members 1 to 5 and a seal 7, formed from synthetic rubber or the like, for interposing among the members 1 to 5 are used as auxiliary members of the members 1 to 5.

The measuring pipe member 1 has a straight conduit 1a, which is a measuring conduit, in a central portion, and a rib 1b for reinforcement is provided in a periphery of the straight conduit 1a. Flanges 8 to be linked one each to the first and second element attachment members 2 and 3 protrude at either end of the measuring pipe member 1.

The flanges 8 are disposed in such a way as to enclose the straight conduit 1a in centers thereof, and cross-sections perpendicular to a central axis of the straight conduit 1a are approximately rectangular. The cross-sections not being limited to being approximately rectangular, an appropriate form can be employed provided that it is bilaterally symmetrical and/or vertically symmetrical.

Also, a corner portion of the protruding rectangular flange 8 is cut away, and a circular annular recessed portion 9 for enclosing the seal 7 is formed in an inlet/outlet of the straight conduit 1a, which is a fluid conduit on an inner side of the flange 8.

The first element attachment member 2 is a member for attaching an ultrasonic transceiving element formed of an unshown piezoelectric element, and has an approximately L-shaped curved conduit 2a, which is a fluid conduit, in a central portion. The flange 8 and the annular recessed portion 9 for linking to each of the measuring pipe member 1 and the inflow pipe member 4 are formed in the same way as in the measuring pipe member 1 in an inlet/outlet at either end of the curved conduit 2a.

In the same way, the second element attachment member 3, which includes an ultrasonic transceiving element, also has an approximately L-shaped curved conduit 3a, which is a fluid conduit, in a central portion, and the flange 8 and the annular recessed portion 9 for linking to each of the measuring pipe member 1 and the discharge pipe member 5 are formed in the same way as in the measuring pipe member 1 in an inlet/outlet at either end of the curved conduit 3a.

The inflow pipe member 4 is linked to the other end of the first element attachment member 2, and the discharge pipe member 5 is linked to the other end of the second element attachment member 3. The inflow pipe member 4 has an inflow conduit, which is a straight pipe or a curved pipe for causing a fluid to be measured to flow into the measuring pipe member 1, the flange 8 and the annular recessed portion 9 for linking to the first element attachment member 2 are provided at one end of the inflow pipe member 4, and a supply pipe 10 for supplying the fluid can be connected to the other end of the inflow pipe member 4 using a fastening nut 4a.

The discharge pipe member 5 has a form the same as that of the inflow pipe member 4, a discharge conduit and a fastening nut 5a of the discharge pipe member 5 correspond to the inflow conduit and the fastening nut 4a of the inflow pipe member 4, and a discharge pipe 11 that discharges the fluid can be connected to another end of the discharge pipe member 5.

As shown in FIG. 3, the link fitting 6 is formed of a pair of parallel clamping pieces 6a and 6a, which have an arc form that comes into contact with an outer face of a conduit, and three joining pieces 6b, 6c, and 6d that link the clamping pieces 6a and 6a, and between the joining pieces 6b and 6c and the joining pieces 6c and 6d there is a window portion 6e. A gap between the clamping pieces 6a and 6a, that is, a width in the thickness direction of the flange 8 of the window portion 6e, is approximately equivalent to a combined thickness of the flanges 8. Also, protruding pins 6f are formed two each, to a total of four, on inner sides of the clamping pieces 6a and 6a.

The link fitting 6 is configured of one set, and other than the heretofore described form, which is such that the link fitting 6 is fitted from both sides, a configuration such that a multiple of insertion hole portions are provided in the flange 8, and the flange 8 is linked and fixed using a bolt, a nut, or the like inserted through the insertion hole portions, may be employed as the link fitting 6.

A groove portion 8a oriented in a direction parallel to the straight conduit 1a is formed in each side portion of the approximately rectangular flange 8, a fitting piece 8b, which is a protruding portion, is formed on both sides of the groove portion 8a, and furthermore, two pin holes 8c, into which the pin 6f of the link fitting 6 is fitted and which have positioning and retaining functions, are formed in each side portion of the flange 8.

The seal 7 is an annular elastic body having thickness, is inserted between the annular recessed portions 9 of the linking portions of the members 1 to 5, and performs a role of preventing water from leaking from the linking portions of the members 1 to 5. Rather than being an independent part, the seal 7 may be appended to one side of the members 1 to 5 to be linked.

In order to link the members 1 to 5, using one set of link fittings 6 from either side with respect to a combined portion 8d in one place in which flanges 8 are combined, the seal 7 is interposed between the annular recessed portions 9, and linking is carried out by fitting the fitting pieces 8b of the combined portion 8d formed of fitting pieces 8b into the link fitting 6. That is, in order to carry out linking, one pair of link fittings 6 are pressed one from either side against the combined portion 8d, whereby the fitting piece 8b of the combined portion 8d is sandwiched by the clamping pieces 6a and 6a, and the central joining piece 6c, which is an embedding portion, is fitted into the groove portion 8a, and the combined two fitting pieces 8b are fitted into the window portion 6e.

Furthermore, two each of the pins 6f are fitted into the pin holes 8c, whereby the link fitting 6 is accurately positioned on the flange 8, and fitting of the link fitting 6 on the flange 8 is carried out. Because of this, there is no unexpected separation of the combined two flanges 8, and linking of an orientation of 90 degrees each is clear, in addition to which movement with respect to a direction of rotation can be regulated.

As heretofore described, the members 1 to 5 can be linked using the link fitting 6 by selecting any side portions on the periphery of the approximately rectangular flange 8, because of which assembly can be carried out in a form compatible with a disposition environment. However, by not providing the groove portion 8a in a certain side portion of the flange 8, as also shown in FIG. 3, the link fitting 6 cannot be fitted into the side portion, whereby selection of linking direction can be limited.

Also, as a modification of the link fitting 6, a joint portion joining the clamping pieces 6a and 6a can be a joining plate in which the three joining pieces 6b, 6c, and 6d are integrated, rather than being formed of the joining pieces 6b, 6c, and 6d. In this case, an embedding portion that is fitted into the groove portion 8a of the flange 8 is provided on an inner side of the joining plate.

Furthermore, instead of linking to the groove portion 8a and the fitting piece 8b of the flange 8 using the link fitting 6, a protruding portion may be provided on the flange 8 and a recessed portion in the link fitting 6, and linking carried out using the protruding portion and the recessed portion.

In this way, an assembled ultrasonic flowmeter is such that when calibrating or using, each of the fluid supply pipe 10, the discharge pipe 11, and signal lines 12 and 13 is connected to the inflow pipe member 4 and the discharge pipe member 5. In order to measure a flow rate of a fluid flowing along the measuring pipe member 1, signals are alternately transmitted and received via the signal lines 12 and 13 connected to the ultrasonic transceiving elements attached one each to the first and second element attachment members 2 and 3, and an ultrasonic beam can be transmitted to the fluid inside the straight conduit 1a of the measuring pipe member 1. As a principle whereby transmission times of an outward path and a return path of the ultrasonic beam are each measured, a flow velocity is measured using a difference between the times, and a flow rate is obtained is publicly known, a further description will be omitted.

Also, in the working example, two link fittings 6 are used for each linking portion of the members 1 to 5, but the form of the link fitting 6 may be adjusted, and three or four used as necessary. Furthermore, the link fitting 6 is formed for each side portion, but by using one set of link fittings 6 connected by a connecting piece with respect to, for example, two side portions, a multiple of side portions can be linked simultaneously.

The joint structure according to the present application has been described with at least one of linked structural bodies as one portion of an ultrasonic flowmeter, but other than an ultrasonic flowmeter, the joint structure can be applied in the same way to one portion of a flow rate controller that measures a mass flow rate of a fluid, and carries out flow rate control.

In this way, according to the joint structure of the present application, the joint structure is used in, for example, an ultrasonic flowmeter or a flow rate controller, and when linking structural bodies that include a fluid conduit, no dedicated linking jig, welding operation, turning operation using a screw structure, or the like is needed, and the structural bodies can be linked easily while conserving space.

What is claimed is:

1. A joint structure that links end portions of structural bodies that include fluid conduits, causing the fluid conduits to communicate, wherein
at least one of the structural bodies is provided as one portion of an ultrasonic flowmeter or one portion of a flow rate controller,
a flange that is disposed in such a way as to enclose the fluid conduit in a center thereof, and whose cross-section, which is perpendicular to a central axis of the fluid conduit, is bilaterally symmetrical and/or vertically symmetrical, is disposed in an end portion of the structural body,
the structural bodies are linked using link fittings to a linking portion in which a multiple of the flange, which are of the same form, are combined,
the structural bodies are linked by fitting one set of the link fittings from both sides to the linking portion in one place,
the link fitting is configured of one pair of parallel clamping pieces and a joining portion that joins the pair of clamping pieces,
a groove portion or a protruding portion is formed in an edge portion of the flange,
an embedding portion or a recessed portion that fits into the groove portion or onto the protruding portion of the flange is formed in the link fitting,
the joining portion is formed of three joining pieces, and
the central joining piece is the embedding portion.

2. The joint structure according to claim 1, wherein
a window portion is formed between the joining pieces of the link fitting,
a protruding piece is formed on both sides of the groove portion, and
the protruding piece is fitted into the window portion simultaneously with the embedding portion being fitted into the groove portion.

3. A joint structure that links end portions of structural bodies that include fluid conduits, causing the fluid conduits to communicate, wherein
at least one of the structural bodies is provided as one portion of an ultrasonic flowmeter or one portion of a flow rate controller,
a flange that is disposed in such a way as to enclose the fluid conduit in a center thereof, and whose cross-section, which is perpendicular to a central axis of the fluid conduit, is bilaterally symmetrical and/or vertically symmetrical, is disposed in an end portion of the structural body,
the structural bodies are linked using link fittings to a linking portion in which a multiple of the flange, which are of the same form, are combined,
the structural bodies are linked by fitting one set of the link fittings from both sides to the linking portion in one place,
a groove portion or a protruding portion parallel to the central axis of the fluid conduit is formed in an edge portion of the flange, and
the link fitting is configured of one pair of parallel clamping pieces and a joining portion that joins the pair of clamping pieces, and in which an embedding portion or a recessed portion that is fitted into the groove portion or onto the recessed portion of the flange is formed.

4. The joint structure according to claim 1, wherein a pin is formed on an inner side of the clamping piece of the link fitting, and a pin hole into which the pin is fitted is formed in the flange.

5. The joint structure according to claim 1, wherein the cross-section of the flange is approximately rectangular, and
the groove portion is formed in a center of a side portion, which is the edge portion of the flange.
